(19) United States
(12) Patent Application Publication
(10) Pub. No.: US 2014/0200968 A1
(43) Pub. Date: Jul. 17, 2014

(54) SYSTEM AND METHOD FOR DETERMINING COMPETITIVE OPPORTUNITY METRICS AND INDICES

(71) Applicant: Visa International Service Association, San Francisco, CA (US)

(72) Inventors: Jeanette Yoder, Foster City, CA (US); Allison Cripps, Foster City, CA (US)

(73) Assignee: Visa International Service Association, San Francisco, CA (US)

(21) Appl. No.: 14/155,086

(22) Filed: Jan. 14, 2014

Related U.S. Application Data
(60) Provisional application No. 61/752,858, filed on Jan. 15, 2013.

(51) Int. Cl. G06Q 10/06

(52) U.S. Cl. CPC G06Q 10/06393
USPC 705/7.39

(57) ABSTRACT

A system and method for assessing competitive opportunities is provided. Transaction records for a merchant peer group are identified, wherein the records are associated with a predetermined period of time. A competitive opportunity metric is determined for a particular merchant from the merchant peer group based on computer processing a first subset of the transaction records. A peer group competitive opportunity metric is determined based on computer processing a second subset of the transaction records. An index is generated based on the competitive opportunity metric and the peer group competitive opportunity metric to indicate performance of the particular merchant relative to the merchant peer group.

### CROSS REFERENCE TO RELATED APPLICATIONS

This application claims the benefit of, and priority to, U.S. Provisional Patent Appl. Ser. No. 61/752,858, filed Jan. 15, 2013, titled “System And Method For Determining Competitive Opportunity Metrics And Indices,” the content of which is incorporated herein by reference in its entirety.

### BACKGROUND OF THE INVENTION

1. Field of the Invention

The invention relates to systems and methods for determining competitive opportunity metrics and indices. Among other fields and applications, the invention has utility in analyzing transaction records to permit merchants to assess their performance relative to their peer group.

2. Description of Related Art

Millions of transactions occur daily through the use of payment cards, such as credit cards, debit cards, prepaid cards, etc. Corresponding records of the transactions are recorded in databases for settlement and financial recordkeeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008, entitled “Techniques for Target Offers.”

When a payment card is tendered as payment, communications are passed from a point of sale terminal over a payment network to authorize payment. The authorization process creates transaction data for the requested transaction. Merchants, however, lack tools to analyze this data to assess their performance relative to peer group competitors. Moreover, merchants may have misconceptions about their performance relative to peer group competitors and may make business decisions that detrimentally affect their financial position. Therefore, a need exists for providing tools to permit merchants to compare their business to competitors.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows a block diagram illustrating example aspects of a system for determining competitive opportunity metrics and indices in accordance with example embodiments.

FIG. 2 illustrates a block diagram of a transaction database and analysis server of FIG. 1 in accordance with example embodiments.

FIG. 3 illustrates a diagram of metrics determined by analysis server in accordance with example embodiments.

FIGS. 4A-B illustrate example metrics determined from analyzing transaction records in accordance with example embodiments.

FIG. 5 includes a chart showing trends in index values in accordance with example embodiments.

FIG. 6 shows an example chart illustrating the effect of a percentage point increase in multiple metrics in accordance with example embodiments.

FIG. 7 illustrates a chart showing a spend metric over time for a particular merchant and an average spend metric for merchants in a peer group.

FIG. 8 illustrates an example table of customer segments in accordance with example embodiments.

FIG. 9 illustrates a loyalty chart comparing spend metrics from a first period to a second period in accordance with example embodiments.

FIG. 10 illustrates a flow chart of a method for determining an index in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system, apparatus, computer readable media, and method are disclosed for generating an index indicative of merchant performance relative to peer merchants. Specifically programmed computer hardware may generate such indices based on analyzing and computer processing of payment transaction data. In some examples, the specifically programmed computer hardware may be hardwired to perform functionality described herein, may include one or more specifically programmed software modules executing specialized computer instructions to perform functionality described herein, and/or combinations thereof. For example, the specifically programmed computer hardware may generate indices indicating a merchant's ticket size relative to peers and a visit frequency of a merchant's customers relative to peers.

In a further example, transaction records for a merchant peer group are identified, wherein the records are associated with a predetermined period of time. A competitive opportunity metric is determined for a particular merchant from the merchant peer group based on computer processing a first subset of the transaction records. A peer group competitive opportunity metric is determined based on computer processing a second subset of the transaction records. An index is generated based on the competitive opportunity metric and the peer group competitive opportunity metric to indicate performance of the particular merchant relative to the merchant peer group.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, or devices. Accordingly, the present invention may take the form of an entirely hardware embodiment, an entirely software embodiment, or an embodiment combining software and hardware aspects. The following detailed description is, therefore, not to be taken in a limiting sense.

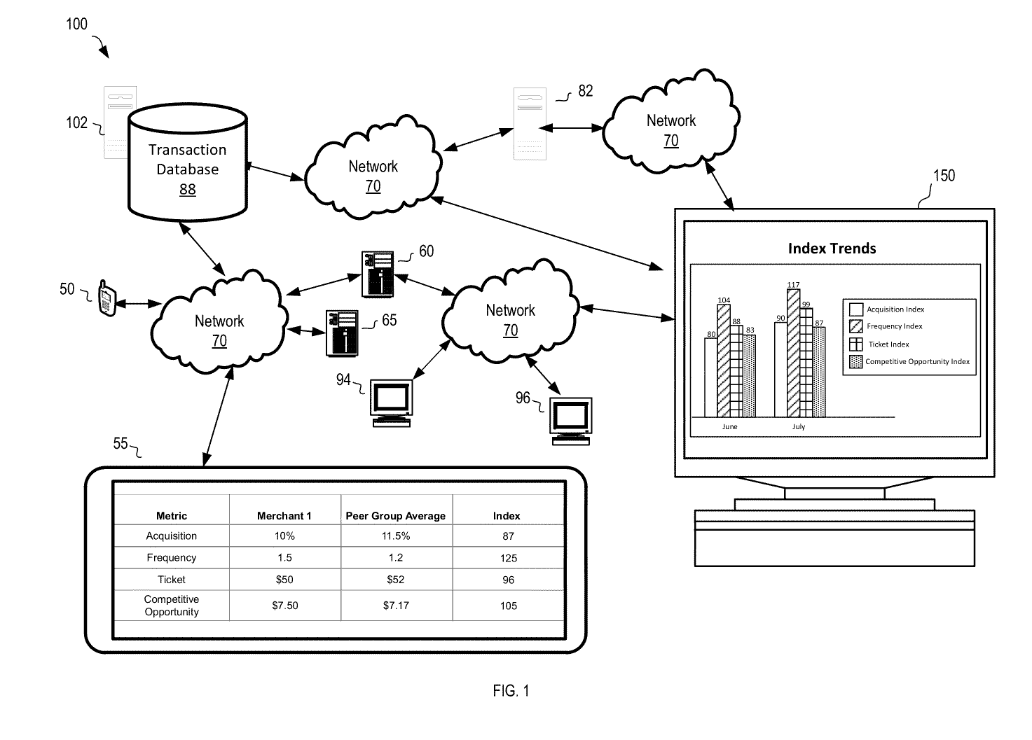

FIG. 1 illustrates a block diagram of a system 100 for determining competitive opportunity metrics and indices in accordance with example embodiments. System 100 may include one or more client or merchant terminals 50 and 55, one or more e-commerce provider servers 60 and 65, one or more payment network servers 102, which may include transaction database 88, one or more merchant servers 82, one or more analysis servers 150, and one or more e-commerce provider user terminals 94 and 96. Networks 70 are shown interconnecting various components. Networks 70 may be the Internet, WAN, LAN, Wi-Fi, other computer networks (now known or invented in the future), and/or any combination of the foregoing. It should be understood by those of ordinary skill in the art having the present specification, drawings, and claims before them that networks 70 may connect the various components over any combination of wired and wireless conduits, including copper, fiber optic, microwaves, and other forms of radio frequency, electrical and/or optical communication techniques. It should also be understood that any network 70 may be connected to any other network 70 in a different manner. The interconnections between devices in system 100 are examples. Any device depicted in FIG. 1 may communicate with any other device via one or more of the networks 70.

Servers 60, 65, 82, 102, and 150 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Servers 60, 65, 82, 102, and 150 may be running on any one of many operating systems including, but not limited to WINDOWS (XP, VISTA, etc.), UNIX, LINUX, JAVA, or MAC OS. It is contemplated, however, that any suitable operating system may be used for the present invention. Servers 60, 65, 82, 102, and 150 may be one or may be a cluster of web servers, which may each be LINUX based and supported by a load balancer that decides which of the cluster of web servers should process a request based upon the current request-load of the available server(s).

Payment network server 102 may acquire, send, process, and store information in conjunction with transaction database 88. In an example, payment network server 102 may process payment transactions from a merchant terminal 55 (e.g., point of sale terminal or device associated with a physical store where customers make purchases), an e-commerce server 60, or other device. When processing a payment transaction, payment network server 102 may store, in transaction database 88, merchant data (e.g., data about sellers including a merchant ID), customer spend data (e.g., transactions between sellers and buyers over time), information of merchants, categories of the merchants, and may further include geographical location categories of products and services provided by merchants. Merchant information associated with a transaction may also be determined using the merchant ID recorded for the transaction. In some examples, a merchant may have multiple stores and a unique ID may be associated with each store (e.g., store1, store 2, etc.). Transaction database 88 may be comprised of one or more databases and may store information including and related to average income, geographic information, and other demographic data. Transaction database 88 may be provided by one or more third parties (e.g., large database providers), one or more issuers, or a combination of one or more issuers and third parties. Data may be provided on an on-demand basis or may be batch delivered to analysis server 150.

Terminals 50, 55, 94, and 96 may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones (e.g., iPhone), computers, laptops, and the like. In one aspect, the general-purpose computer may be controlled by the WINDOWS XP operating system. It is contemplated, however, that the present system would work equally well using a MACINTOSH computer or even another operating system such as a WINDOWS VISTA, UNIX, LINUX or a JAVA based operating system, to name a few.

Terminals 50, 55, 94, and 96 may operably connect to servers 60, 65, 82, 102, and 150, via one of many available internet browsers including, but not limited to, Microsoft's Internet Explorer, Apple's Safari, and Mozilla's Firefox. Via any of networks 70, end users may access the system 100 with, for example an http-based or https-based, website, although other graphical user interfaces can be used with the present system. Information entered by an end user via terminals 50, 55, 94, and 96 may be encrypted before transmission over a network for security. There are several commercially available encryption programs or algorithms available including, but not limited to, PC1 Encryption Algorithm, TrueCrypt, a Symantec encryption program, Blowfish, and Guardian Edge.

E-commerce provider servers 60 and 65 may provide a digital marketplace through which on-line merchants may provide services, offer products for sale, and provide offers and deals. In an example, e-commerce provider servers 60 and 65 may host websites that can be accessed by client or merchant terminals 50 and 55 via network 70.

Transactions occurring through client or merchant terminals 50 and 55, servers 60 and 65, payment network servers 102, merchant servers 82, e-commerce provider terminals 94 and 96, and accompanying networks 70 are portions of system 100 through which expenditures may be made for an account. Information such as type of merchant, type of purchase, type of good or service, may be collected and transferred directly or indirectly to analysis server 150 in addition to information from transaction database 88.

Analysis server 150 may be running on any one of many operating systems including, but not limited to WINDOWS (XP, VISTA, etc.), UNIX, LINUX, JAVA, or MAC OS. It is contemplated, however, that any suitable operating system may be used for the present invention. Analysis server 150 may be a cluster of web servers, which may each be LINUX based and supported by a load balancer that decides which of the cluster of web servers should process a request based upon the current request-load of the available server(s). Other server operating systems may be used for analysis server 150.

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices. System 100 may determine metrics and indices for comparing a particular merchant's performance relative to a peer group based on information provided to and/or obtained by analysis server 150 from a variety of sources including those depicted in FIG. 1, such as, for example, transaction database 88.

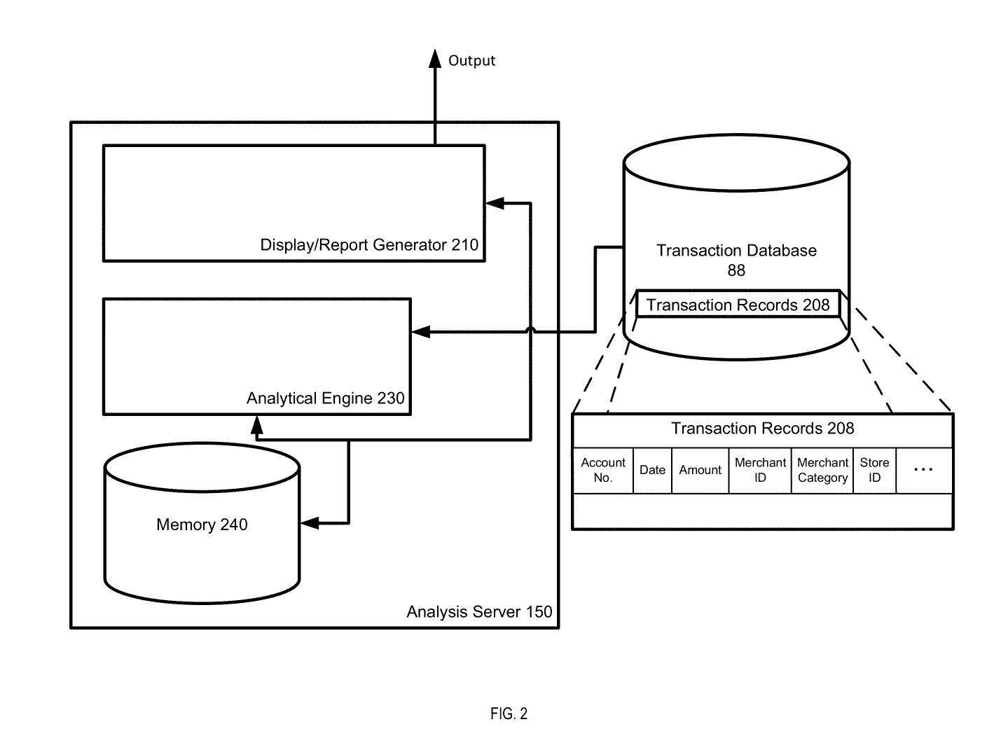

FIG. 2 illustrates a block diagram of the transaction database 88 and analysis server 150 of FIG. 1 in accordance with example embodiments. Analysis server 150 may be connected to transaction database 88 through networks 70 as illustrated in FIG. 1. Analysis server 150 includes specifically programmed computer hardware performing the functions described herein. Examples of the specifically programmed computer hardware include display/report generator 210, analytical engine 230, and memory 240. In some examples, the specifically programmed computer hardware may be hardwired to perform functionality described herein, may include one or more specifically programmed software modules executing specialized computer instructions to perform functionality described herein, and/or combinations thereof. Transaction database 88 may include transaction records 208.

Transaction records 208 stored in database 88 may be acquired from various client and merchant terminals via networks 70. Transaction records 208 may include, for example, one or more of account number information, date of purchase information, purchase amount, merchant ID, store ID, merchant categories, and the like. In some embodiments, transaction records may include details about the products and/or services involved in the purchase. For example, a list of items purchased in the transaction may be recorded together with the respective purchase prices of the items and/or the respective quantities of the purchased items. The products and/or services can be identified via stock-keeping unit (SKU) numbers, or product category IDs. The purchase details may be stored in a separate database and be looked up based on an identifier of the transaction.

Transaction records 208 along with other information from transaction database 88 (such as merchant information) provide input for the analysis server 150. Analytical engine 230 is configured to execute instructions, such as instructions physically coded into the analytical engine 230, instructions stored in memory 240, instructions stored over a network 70, or from a combination of sources. Analytical engine 230 receives information from transaction database 88 and performs analysis in accordance with the subject technology. Memory 240 be comprised of one or more databases and may be physically located in analysis server 150 or connected to analysis server 150 through any network 70. Memory 240 may be volatile, non-volatile, or may incorporate both. Memory 240 may store instructions that are executed by analytical engine 230 to determine metrics and indices, and may also store database historical information on metrics and indices.

Display/report generator 210 receives information from analytical engine 230 and/or memory 240 and provides display and report information as output to any device configured to receive and/or display such information including, but not limited to, client devices, merchant terminals, and servers. The output of display/report generator 210 may be presented by itself or combined with the outputs of other analyses to form a dashboard of metrics (not shown) that may be useful and/or interesting to merchants in operating their businesses.

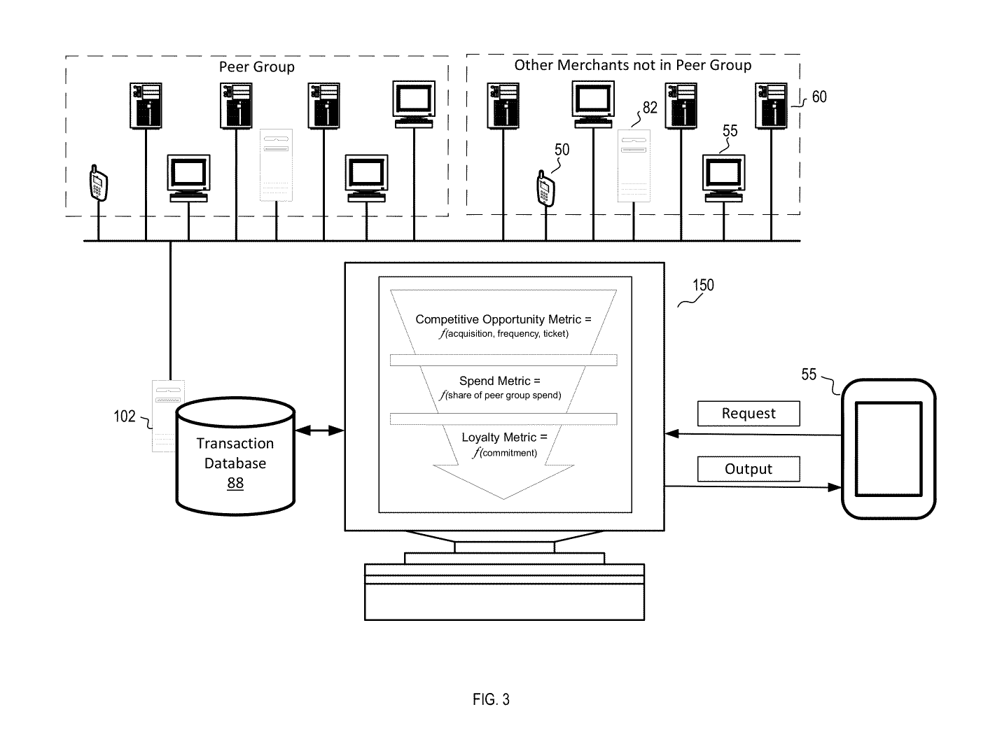

FIG. 3 illustrates a diagram of metrics determined by analysis server in accordance with example embodiments. In an example, payment network server 102 may process payment transactions received from a number of e-commerce servers 60, merchant terminals 55, merchant servers 82, etc., of merchants in the same and differing peer groups. There may be various ways to define the scope of a merchant's peer group. Merchants may fall within a merchant peer group based on falling within a merchant category (e.g., as represented by a merchant category code (MCC), a North American Industry Classification System (NAICS) code, or a similarly standardized category code). In some instances, the peer group may be further narrowed by breaking MCC codes down into more specific segments. The peer group may further or alternatively narrowed beyond MCC by considering the group member's annual sales volume, sales channel (e.g. online, in-store, etc.), number of physical stores, geo-location(s) of the stores, number of employees, number of unique customers, etc. In another example, the peer group may be defined geographically without regard for MCC code. This type of peer group could be further limited to retailers versus restaurants, etc. The definition of the peer group will generally depend upon the needs of the end user for the analysis.

For example, FIG. 3 illustrates servers/terminals of merchants in a peer group and other servers/terminals of merchants not in the peer group. Payment network server 102 may generate transaction records 208 based on processing the process payment transactions. The number of transaction records 208 included in transaction database 88 may change over time, and analysis server 150 may frequently (e.g., periodically) query transaction database 88 for at least a portion of the transaction records 208. For example, a merchant terminal 55 may communicate a request to analysis server 150 for comparing the merchant to its peer group. Analysis server 150 may query transaction database 88 for transaction records 208 of the requesting merchant and of peer group merchants. Analysis server 150 may analyze the transaction records 208 to determine one or more metrics to indicate how the merchant is performing relative to merchants in their peer group, and may output the metrics to the merchant terminal 55 for presentation (e.g., display in a graphical user interface, audio output, etc.).

Example metrics include a spend metric, a loyalty metric, and a competitive opportunity metric. The spend metric may represent the share of expenditure a particular merchant has relative to total customer spend in the peer group. The loyalty metric may be a measure of customer loyalty determined from monitoring changes in the spend metric over time.

The competitive opportunity metric may be a measure that can be tracked over time to reveal growth or decline in business for a particular merchant relative to a peer group. In an example, a competitive opportunity metric may be defined as a merchant's yield per payment account used at least once within a merchant peer group during a predetermined time period (e.g., day, week, month, year, etc.). A payment account may be associated with one or more of a credit card, debit card, reward card, gift card or other payment card via a multiple digit personal account number (PAN). Accounts may alternatively or additionally be associated with a checking account, savings account, on-line account, or other account of one or more users. One account of the plurality of accounts may constitute an account of a user that includes several different accounts. An account of a user may be all the accounts for a household, several cards linked to a single bank account, all the accounts of an individual, several different accounts that are associated with an individual, all the accounts associated with a physical address, all or some of the accounts associated with an individual at a single physical address, or the like. The accounts that are identified may include some or all of the accounts that are associated with a physical address located within a zip code, or zip+4 code.

In an example, analysis server 150 may determine the competitive opportunity metric by multiplying one or more metrics. Example metrics include an acquisition metric, a frequency metric, and a ticket metric. The acquisition metric may be the number of payment accounts active at a particular merchant divided by a total number of payment accounts active at any merchant within the merchant peer group. The frequency metric may be the average number of transactions per account at the particular merchant. The ticket metric may be the total spend amount for the payment accounts used at a particular merchant divided by the corresponding number of transactions.

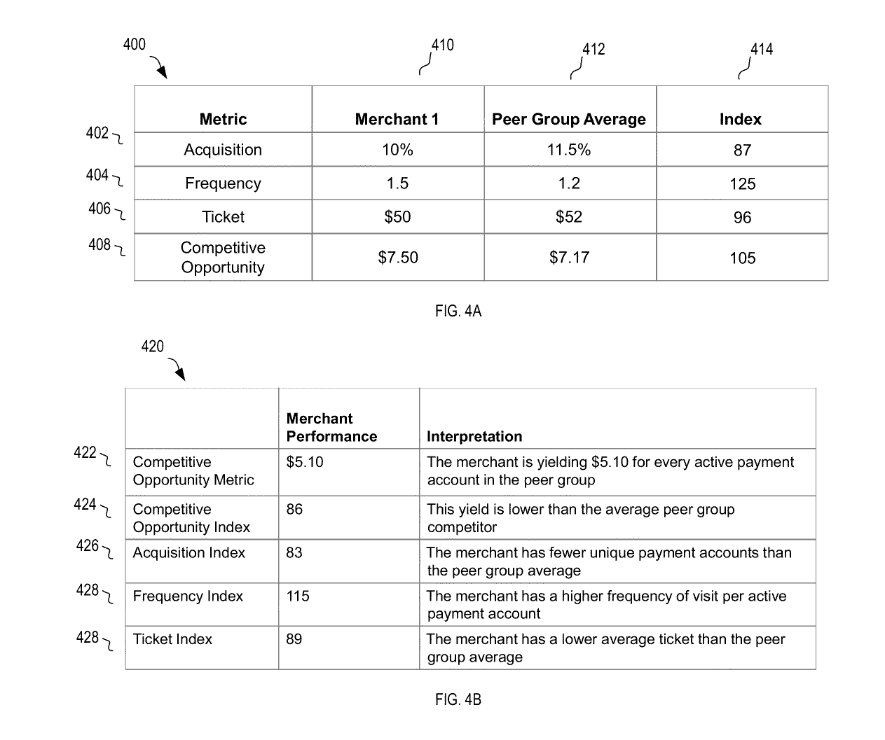

FIGS. 4A-4B illustrate example metrics determined from analyzing transaction records in accordance with example embodiments. In an example, analysis server 150 may receive a request for metrics directed to a particular merchant during a predetermined time period. In some examples, a merchant may only obtain metrics on their business for comparison to other merchants in their peer group. Where the definition of a merchant's peer group would result in a merchant obtaining metrics about a particular competitor, the analysis server 150 may prevent generation of any substantive metrics. If a peer group is sufficiently small, analysis server 150 may also similarly deny the request to prevent one merchant from obtaining detailed information about specific competitors. A merchant may also have one or more lines of business and may specify in the request to compare a particular line of business to other merchants within that same line of business. Merchants may also parse their business by sales channel (e.g., online versus in-store), by geographic location (e.g., by area code, city, state, etc.), by store, by type of payment account (e.g., credit card, debit card, electronic check, gift card, etc.), and the like.

In a more detailed example, a merchant may request metrics for comparing performance of their hardware store in Foster City, California during 6-9 AM on Saturdays against in-store sales of other peer group hardware stores within a 15 mile radius. This request may be further limited to a particular month (e.g., May) or season (e.g. Spring).

Analysis server 150 may process the request to identify a merchant identifier associated with the particular merchant. Analysis server may also identify merchant identifiers of peer merchants, accounting for any other restrictions specified in the request (e.g., location, channel, time period, etc.). Analysis server 150 may generate a query including the merchant identifiers and providing any filters based on the specified restrictions. Analysis server may communicate the query to the transaction database 88, which may retrieve the transaction records 208 having a merchant identifier for any of the merchants in the merchant peer group, accounting for the filters. In an example, analysis server 150 may determine that there are 10,000 payment accounts that have been used at least once within the predetermined time period at one or more merchants in the peer group.

The transaction records may be processed to generate metrics for comparing the particular merchant to the merchant peer group. With reference to row 402 in table 400 (see FIG. 4A), analysis server 150 may determine that 1,000 of the payment accounts have been used at the particular merchant and may determine an acquisition metric for the particular merchant (e.g., 1,000 active payment accounts at target merchant/10,000 active at any merchant within peer group=10%). Analysis server 150 may make a similar determination for the merchant peer group and may, for example, determine that the peer group has an average acquisition metric of 11.5%. Analysis server 150 may determine an index value for the acquisition metric by dividing the particular merchant's acquisition metric by the average acquisition metric, and multiplying the result by 100 Continuing this example, analysis server 150 determines an acquisition index of 87 for the particular merchant (e.g., 10%/11.5%*100), as seen in column 414.

Analysis server 150 may also generate a frequency metric by determining the average number of times each payment account was used at the particular merchant during the predetermined time period. Analysis server 150 may similarly determine a frequency metric for the merchant peer group by determining the average number of times each payment account was used at the peer group. For example, with reference to row 404 (see FIG. 4A), analysis server 150 may determine that, on average, each unique payment account was used 1.5 times at the particular merchant during the predetermined time period. Analysis server 150 may determine that, on average, each unique payment account was used 1.2 times at merchants in the peer group during the predetermined time period. Analysis server 150 may determine an index value for the frequency metric by dividing the particular merchant's frequency metric by the average acquisition metric, and multiplying the result by 100. Continuing this example, analysis server 150 determines a frequency index of 125 for the particular merchant (e.g., 1.5/1.25*100), as seen in column 414 (see FIG. 4A).

Analysis server 150 may further generate a ticket metric by aggregating the total spend amount for transactions within the predetermined time period and dividing by the corresponding number of transactions aggregated in the corresponding time period. Analyses server 150 may similarly determine an average ticket metric for the merchant peer group. For example, with reference to row 406 (see FIG. 4A), analysis server 150 may determine that the average ticket at the particular merchant is $50, and the average ticket at the other merchants in the peer group is $52. Analysis server 150 may determine an index value for the ticket metric by dividing the particular merchant's ticket metric by the average ticket metric, and multiplying the result by 100. Continuing this example, analysis server 150 determines a ticket index of 96 for the particular merchant (e.g., $50/$52*100), as seen in column 414 (see FIG. 4A).

The competitive opportunity metric may be determined as a function of two or more of the acquisition metric, the frequency metric, and the ticket metric. In an example, analysis server 150 may determine the competitive opportunity metric as a product of the acquisition metric, the frequency metric, and the ticket metric. With reference to column 410 of FIG. 4A, analysis server 150 may determine a competitive opportunity metric of $7.50 for the particular merchant (e.g., 10%*1.5*$50=$7.50). With reference to column 412 of FIG. 4A, analysis server 150 determine a competitive opportunity metric of $7.17 for the merchant peer group (e.g., 11.5%*1.2*$52=$7.17), as seen in column 414.

A competitive opportunity metric index may be determined for indicating how the particular merchant is performing relative to the peer group. In some instances, the competitive opportunity metric index may be a function of the competitive opportunity metric and the peer group competitive opportunity metric. For example, analysis server 150 may divide the competitive opportunity metric by the peer group competitive opportunity metric, and multiply the result by 100, to determine the competitive opportunity metric index (e.g., $7.50/$7.17*100=105) for the particular merchant, as seen in column 414 (see FIG. 4A).

The indices in column 414 may indicate how well a particular merchant is performing relative to the merchant peer group. An index value of less than 100 signifies that the particular merchant is performing worse than the average peer group merchant, a value of greater than 100 signifies that the particular merchant is performing better than the average peer group merchant, and an index value of 100 signifies that the particular merchant is performing the same as the average peer group merchant. FIG. 4B illustrates an example table 420 with metrics and indices in accordance with example embodiments specifying example interpretations of how a particular merchant is performing compared to an average peer group merchant.

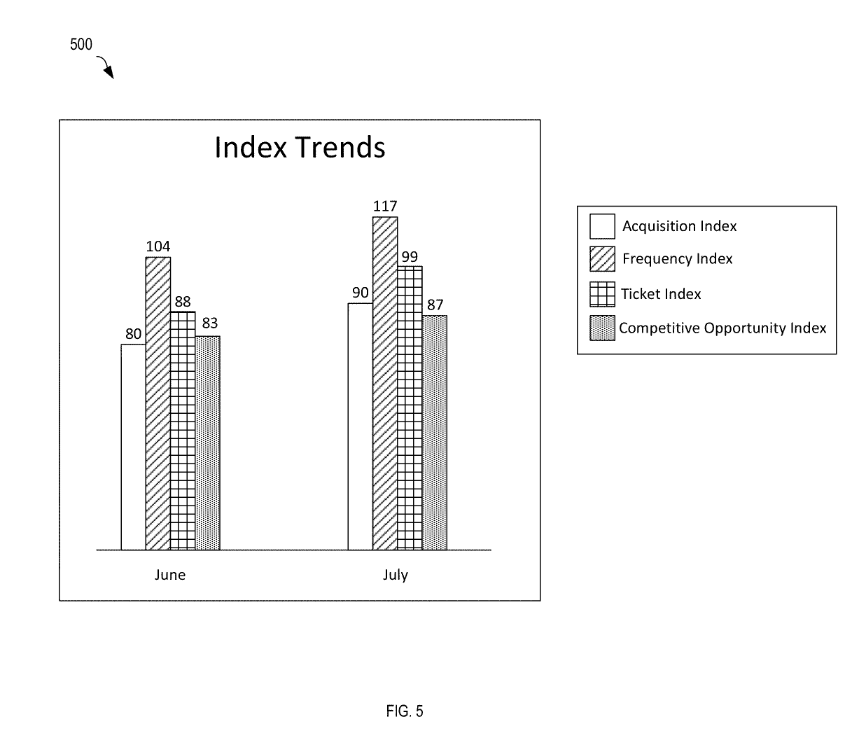

Index trends may be identified based on changes in indices over time. Other time periods may also be compared (e.g., Saturday morning of one week to Saturday morning of a different week). FIG. 5 illustrates an example showing indices for comparing a particular merchant's month to month performance. As can be seen, FIG. 5 includes a chart 500 showing trends in values for the acquisition, frequency, ticket, and competitive opportunity indices for June and July. Other graphical representations, such as line graphs, pie charts, and the like may also be used to show trends in the indices over time. Each of these graphical representation may be presented by themselves or combined with other representations to form a dashboard of metrics (not shown). These metrics may also be combined with other information in a dashboard.

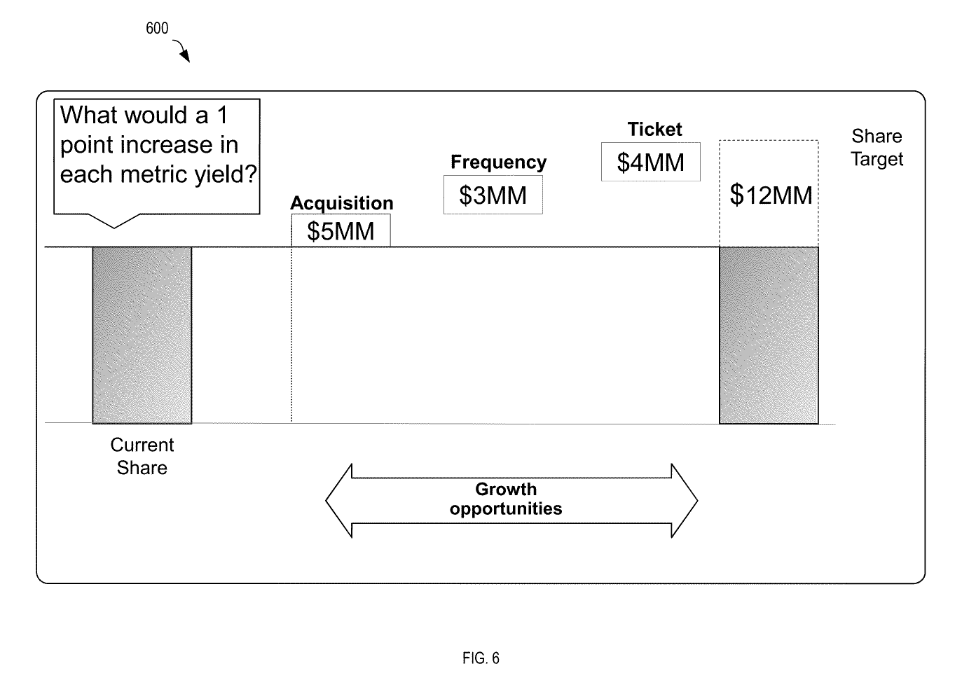

Considering that merchants have limited financial resources, the metrics may be analyzed to show how increases in particular ones of the metrics may affect revenue. FIG. 6 shows an example chart 600 illustrating the effect of a 1 percentage point increase in multiple metrics in accordance with example embodiments. For example, a 1 percentage point increase in the acquisition index may yield $5 million more in revenue, a 1 percentage point increase in the frequency index may yield $3 million more in revenue, and a 1 percentage point increase in the ticket index may yield $4 million more in revenue. After reviewing chart 600, a merchant may focus increasing the acquisition index as a 1 percentage point increase in that index yields the largest potential increase in revenue. Analysis server 150, for example, may communicate recommendations to merchant terminal 50 at periodic or aperiodic times to recommend which index to focus on increasing. These communications (as well as the chart 600) may be displayed as part of the dashboard, but need not be. Alternatively, these period or aperiodic communications may be send to the merchant via email or other type of messaging protocol. The message may even simply direct the merchant to log into a resource from which the information is available for display.

In another aspect, a spend metric may be calculated for determining the share of a customer's spend at a particular merchant as compared to total customer spend within the merchant peer group. In an example, analysis server 150 may receive a request from a particular merchant to obtain their spend metric. As noted above, the request may be restricted to a portion of a merchant's business being analyzed. Similar to the discussion provided above, analysis server 150 retrieves transaction records from transaction database 88 associated with the merchant peer group. Analysis server 88 may process the retrieved transaction records to identify one or more payment accounts that have been used at the particular merchant. For each of the identified accounts, analysis server 150 may determine if nay have been used at any other merchant within the peer group, and if so then determine a total spend within the peer group. Analysis server 150 may divide a total spend at the particular merchant by the total spend at the peer group, and multiply by 100, to calculate the spend metric. Analysis server 150 may make similar calculations for other merchants in the peer group and average those spend metrics to determine an average speed metric for the peer group.

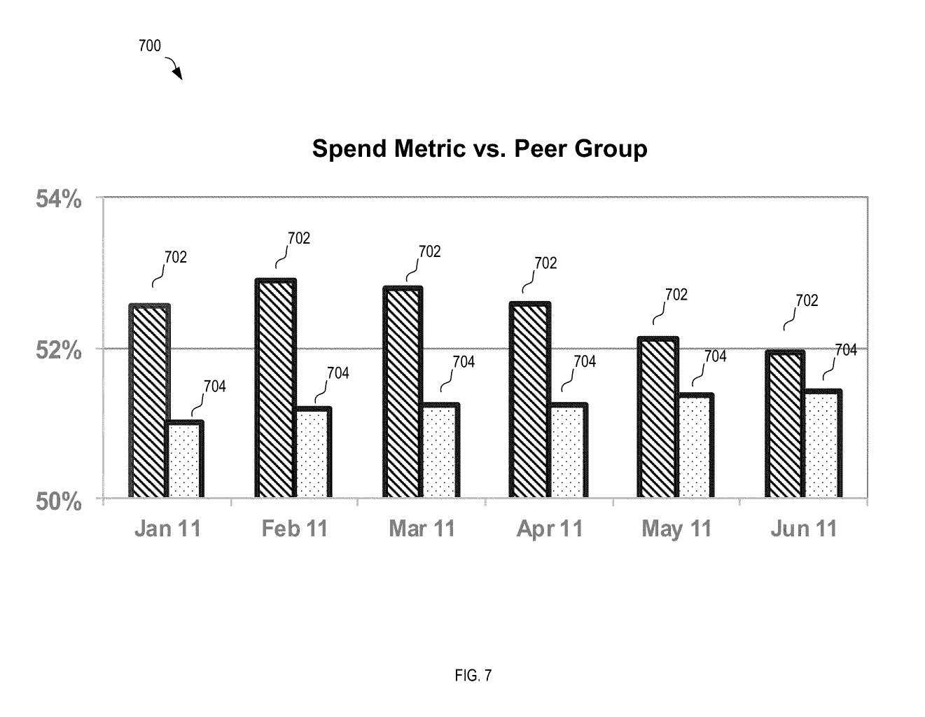

In a more detailed example, analysis server 150 may determine that the average payment account of the particular merchant is used to purchase a total of $1,000 per month at any merchant within the peer group and $530 at the particular merchant, yielding a spend metric of 53% (e.g., $530/$1,000*100) for the particular merchant. Analysis server 150 may similarly determine that the average amount spent using payment accounts at the other merchants is $510, yielding a spend metric of 51% (e.g., $510/$1,000*100). FIG. 7 illustrates a chart 700 showing a spend metric 702 for the particular merchant and an average spend metric 704 for merchants in the peer group over multiple months. Other time periods may also be monitored, and the spend metrics may be shown using other graphical representations and/or as part of an overall dashboard.

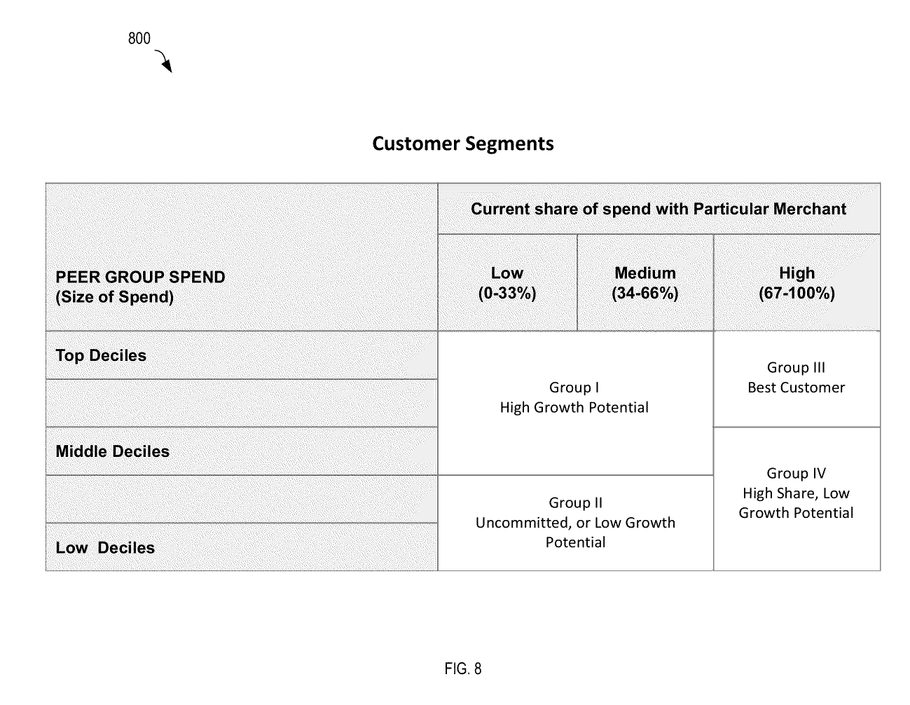

The spend metric may be used to assist merchants in segmenting their customers into categories. FIG. 8 illustrates an example table 800 of customer segments in accordance with example embodiments. As seen in the left most column of table 800, payment accounts may be grouped into deciles based on a total amount of spend. Payment accounts may also be grouped from low to high based on spend metrics. For example, spend metrics between 0-33% may be considered low, between 34-66% may be considered medium, and above 66% may be considered high. Other percentages may also be used.

The relationship between size of spend within the peer group and spend metric may be used to categorize the particular merchant's customers into groups. Group I may correspond to middle to top deciles and spend metrics of 66% of less, reflecting customers that may have high potential for growth if they can be successfully converted into more regular customers. Group II may correspond to low deciles and spend metrics of 66% of less reflecting customers who are uncommitted or who have low potential for growth. Group III may correspond to middle to top deciles and spend metrics of 66% or higher, which may reflect the best customers of the particular merchant. Group IV may correspond to low deciles and spend metrics of 66% of higher, which may correspond to customers where the particular merchant has captured a large amount of their spend, but there is little growth potential.

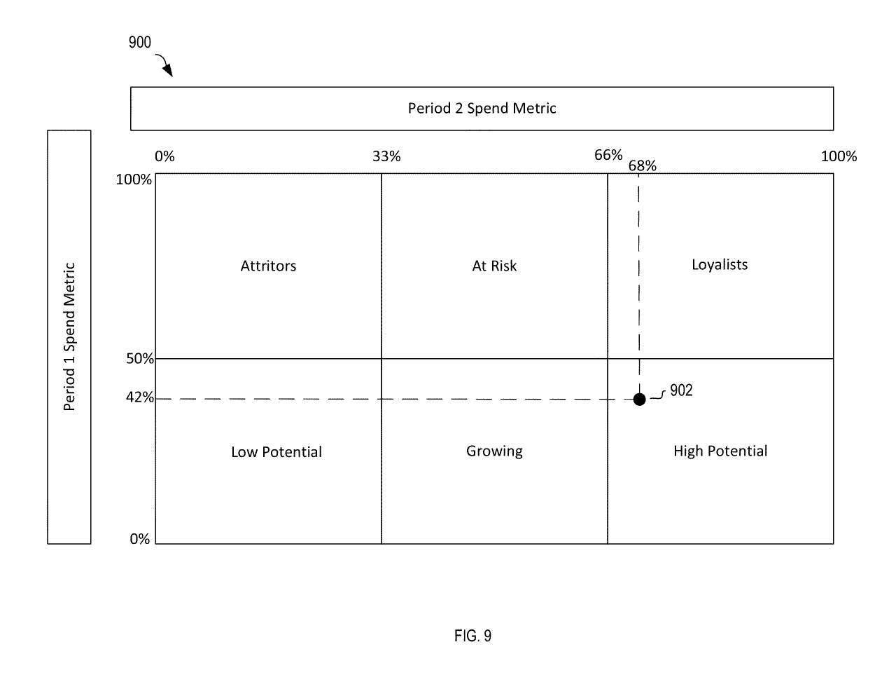

Changes in spend metrics over time may be used to determine customer loyalty. In an example, analysis server 150 may compare spend metrics from different time periods to determine whether customers are becoming more or less loyal. FIG. 9 illustrates a loyalty chart 900 comparing spend metrics from period 1 to period 2 in accordance with example embodiments. Example loyalty categories illustrated in chart 900 are attritors, at risk, loyalists, low potential, growing, and high potential. To determine the category in which a payment account falls, a dot may be placed within chart 900 based on the intersection of straight lines from the spend metric from period 1 and the spend metric for period 2. For example, a payment account may have a spend metric of 42% in period 1, and a spend metric of 68% in period 2. Dot 902 is placed at the intersection of straight lines from these spend metrics and falls within the high potential loyalty category.

Alerts may be generated based on changes in the number of payment accounts falling within a particular loyalty category. Predetermined thresholds for the number of payment accounts within a particular category may be specified by a merchant or recommended by analysis server 150, which may use an algorithm to determine the thresholds. Analysis server 150 may communicate an alert if the number of payment accounts meets or exceeds the threshold (e.g., a ceiling or a floor). For example, a merchant may set a threshold of 20% of payment accounts for the attritor category. If at least 20% of the payment accounts fall within the attritor category, analysis server 150 may communicate an alert to the merchant terminal 50.

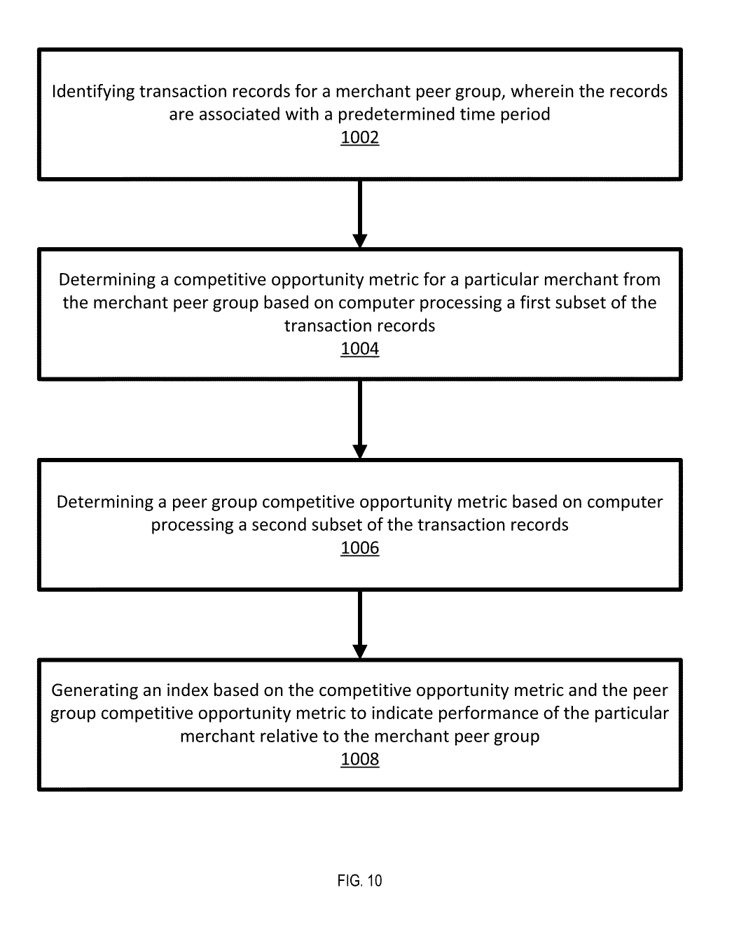

FIG. 10 illustrates a flow chart of a method of determining an index in accordance with example embodiments. The flow diagram may be implemented by a system or apparatus, such as, for example, analysis server 150. Each of the blocks shown in the flow diagram may be repeated one or more times, one or more of the blocks may be modified, and one or more of the blocks may be omitted. Unless otherwise noted or is plainly required by the context, the particular ordering of the blocks may also be modified. The method may be stored on a non-transitory computer readable medium as computer executable instructions. The computer executable instructions, when executed by at least one processor, may cause at least one computer or other device to perform the blocks as steps of a method one or more times. The flow diagram may begin at block 1002.

In block 1002, the method may include identifying transaction records for a merchant peer group associated with a predetermined time period. In an example, analysis server 150 may receive a request from a merchant terminal 50 for analysis of how that particular merchant associated with merchant terminal 50 is performing relative to its peer group during a predetermined time period (e.g., during the month of January 2013). The request may include a merchant identifier. Analysis server 150 may identify merchant identifiers of other merchants in a peer group of the particular merchant. Analysis server 150 may then query transaction database 88 to retrieve transaction records associated with the merchant identifiers and that occurred during the predetermined time period.

In block 1004, the method may include determining a competitive opportunity metric for a particular merchant from the merchant peer group based on computer processing a first subset of the transaction records. In an example, analysis server 150 may determine a competitive opportunity metric based on at least two of an acquisition metric, a frequency metric, and a ticket metric, as discussed above.

In block 1006, the method may include determining a peer group competitive opportunity metric based on computer processing a second subset of the transaction records. In an example, analysis server 150 may process the transaction records associated with the other merchants in the peer group to determine an average competitive opportunity metric for the peer group.

In block 1008, the method may include generating an index based on the competitive opportunity metric and the peer group competitive opportunity metric to indicate performance of the particular merchant relative to the merchant peer group. In an example, analysis server 150 may calculate an index by dividing the competitive opportunity metric of the particular merchant by the peer group competitive opportunity metric. The index may indicate performance of the particular merchant relative to the merchant peer group.

The method in FIG. 10 may end, may repeat one or more times, or may return to any of the preceding blocks. In some instances, the merchant may be a large business having many stores selling products/services, as well as conducting transactions online. The method in FIG. 10 may alternatively or additionally be performed on a portion of the merchant's business or on a particular line of a merchant's business.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques. In some examples, the at least one processor may be specifically programmed.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

The example embodiments may include the means described herein for performing the described functionality. In an example, an apparatus may include means for identifying transaction records for a merchant peer group, wherein the records are associated with a predetermined time period; means for determining a competitive opportunity metric for a particular merchant from the merchant peer group based on computer processing a first subset of the transaction records; means for determining a peer group competitive opportunity metric based on computer processing a second subset of the transaction records; and means for generating an index based on the competitive opportunity metric and the peer group competitive opportunity metric to indicate performance of the particular merchant relative to the merchant peer group. The apparatus may further include means for determining a spend metric for the particular merchant that is a function of a total amount of expenditure at the particular merchant compared to a total amount of expenditure at the peer group. The apparatus may also include means for determining a loyalty metric based on changes in the spend metric over time; means for categorizing the loyalty metric in a particular one of a plurality of loyalty categories; means for determining that a number of payment accounts in the particular category meets or exceeds a threshold; and means for generating an alert in response to the threshold being met or exceeded.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 100 and the methods described herein may be configured to assess competitive opportunities. Further advantages and modifications of the above described system and method will readily occur to those skilled in the art. The disclosure, in its broader aspects, is therefore not limited to the specific details, representative system and methods, and illustrative examples shown and described above.

Various modifications and variations can be made to the above specification without departing from the scope or spirit of the present disclosure, and it is intended that the present disclosure covers all such modifications and variations provided they come within the scope of the following claims and their equivalents.

1. An apparatus comprising:
at least one processor; and
at least one memory storing computer executable instructions that, when executed by the at least one processor, cause the apparatus at least to perform:
identifying transaction records for a merchant peer group, wherein the records are associated with a predetermined time period;
determining a competitive opportunity metric for a particular merchant from the merchant peer group based on computer processing a first subset of the transaction records;
determining a peer group competitive opportunity metric based on computer processing a second subset of the transaction records; and
generating an index based on the competitive opportunity metric and the peer group competitive opportunity metric to indicate performance of the particular merchant relative to the merchant peer group.

2. The apparatus of claim 1, wherein the determining of the competitive opportunity metric is based on multiplying at least two metrics from the group consisting of: an acquisition metric, a frequency metric, and a ticket metric.

3. The apparatus of claim 2, wherein the frequency metric is an average of transaction amounts per unique payment account used to make a purchase at the particular merchant, wherein the acquisition metric is based on a total number of unique payment accounts used at the particular merchant divided by a total number of unique payment accounts used at any merchant in the merchant peer group, and wherein the ticket metric includes a value of the total spend amount for payment accounts used at the particular merchant divided by a corresponding number of transactions.

4. The apparatus of claim 1, wherein the computer executable instructions, when executed by the at least one processor, further cause the apparatus to perform determining a spend metric for the particular merchant that is a function of a total amount of expenditure at the particular merchant compared to a total amount of expenditure at the peer group.

5. The apparatus of claim 4, wherein the computer executable instructions, when executed by the at least one processor, further cause the apparatus to perform:
determining a loyalty metric based on changes in the spend metric over time;
categorizing the loyalty metric in a particular one of a plurality of loyalty categories;
determining that a number of payment accounts in the particular category meets or exceeds a threshold; and
generating an alert in response to the threshold being met or exceeded.

6. An apparatus comprising:
means for identifying transaction records for a merchant peer group, wherein the records are associated with a predetermined time period;
means for determining a competitive opportunity metric for a particular merchant from the merchant peer group based on computer processing a first subset of the transaction records;
means for determining a peer group competitive opportunity metric based on computer processing a second subset of the transaction records; and
means for generating an index based on the competitive opportunity metric and the peer group competitive opportunity metric to indicate performance of the particular merchant relative to the merchant peer group.

7. The apparatus of claim 6, wherein the determining of the competitive opportunity metric is based on multiplying at least two metrics from the group consisting of: an acquisition metric, a frequency metric, and a ticket metric.

8. The apparatus of claim 7, wherein the frequency metric is an average of transaction amounts per unique payment account used to make a purchase at the particular merchant, wherein the acquisition metric is based on a total number of unique payment accounts used at the particular merchant divided by a total number of unique payment accounts used at any merchant in the merchant peer group, and wherein the ticket metric includes a value of the total spend amount for payment accounts used at the particular merchant divided by a corresponding number of transactions.

9. The apparatus of claim 6, further comprising means for determining a spend metric for the particular merchant that is a function of a total amount of expenditure at the particular merchant compared to a total amount of expenditure at the peer group.

10. The apparatus of claim 9, further comprising:
means for determining a loyalty metric based on changes in the spend metric over time;
means for categorizing the loyalty metric in a particular one of a plurality of loyalty categories;
means for determining that a number of payment accounts in the particular category meets or exceeds a threshold; and
means for generating an alert in response to the threshold being met or exceeded.

11. A method comprising:
identifying, by at least one specifically programmed processor, transaction records for a merchant peer group, wherein the records are associated with a predetermined time period;
determining, by the at least one specifically programmed processor, a competitive opportunity metric for a particular merchant from the merchant peer group based on computer processing a first subset of the transaction records;
determining, by the least one specifically programmed processor, a peer group competitive opportunity metric based on computer processing a second subset of the transaction records; and
generating, by the least one specifically programmed processor, an index based on the competitive opportunity metric and the peer group competitive opportunity metric to indicate performance of the particular merchant relative to the merchant peer group.

12. The method of claim 11, wherein the determining of the competitive opportunity metric is based on multiplying at least two metrics from the group consisting of: an acquisition metric, a frequency metric, and a ticket metric.

13. The method of claim 12, wherein the frequency metric is an average of transaction amounts per unique payment account used to make a purchase at the particular merchant.

14. The method of claim 12, wherein the acquisition metric is based on a total number of unique payment accounts used at the particular merchant divided by a total number of unique payment accounts used at any merchant in the merchant peer group.

15. The method of claim 12, wherein the ticket metric includes a value of the total spend amount for payment accounts used at the particular merchant divided by a corresponding number of transactions.

16. The method of claim 11, further comprising determining a spend metric for the particular merchant.

17. The method of claim 16, wherein the spend metric is a function of a total amount of expenditure at the particular merchant compared to a total amount of expenditure at the peer group.

18. The method of claim 16, further comprising determining a loyalty metric based on changes in the spend metric over time.

19. The method of claim 18, further comprising:
categorizing the loyalty metric in a particular one of a plurality of loyalty categories;
determining that a number of payment accounts in the particular category meets or exceeds a threshold; and
generating an alert in response to the threshold being met or exceeded.

20. A method comprising:
identifying, by at least one specifically programmed processor, transaction records for a merchant peer group, wherein the records are associated with a predetermined time period;
determining, by the least one specifically programmed processor, a competitive opportunity metric for a particular merchant from the merchant peer group based on computer processing a first subset of the transaction records, wherein the competitive opportunity metric is based on multiplying an acquisition metric, a frequency metric, and a ticket metric, wherein the frequency metric is an average of transaction amounts per unique payment account used to make a purchase at the particular merchant, wherein the acquisition metric is based on a total number of unique payment accounts used at the particular merchant divided by a total number of unique payment accounts used at any merchant in the merchant peer group, and wherein the ticket metric includes a value of the total spend amount for payment accounts used at the particular merchant divided by a corresponding number of transactions;
determining, by the least one specifically programmed processor, a peer group competitive opportunity metric based on computer processing the transaction records;
generating, by the least one specifically programmed processor, an index based on the competitive opportunity metric and the peer group competitive opportunity metric to indicate performance of the particular merchant relative to the merchant peer group;
determining a spend metric for the particular merchant that is a function of a total amount of expenditure at the particular merchant compared to a total amount of expenditure at the peer group;
determining a loyalty metric based on changes in the spend metric over time;
categorizing the loyalty metric in a particular one of a plurality of loyalty categories;
determining that a number of payment accounts in the particular category meets or exceeds a threshold; and
generating an alert in response to the threshold being met or exceeded.
